(19) United States
(12) Patent Application Publication
(10) Pub. No.: US 2026/0179338 A1
(43) Pub. Date: Jun. 25, 2026

(54) COLOR CORRECTION AND ENHANCEMENT OF DIGITAL IMAGES USING A NON-UNIFORM 3D LOOKUP TABLE

(71) Applicant: SAMSUNG ELECTRONICS CO., LTD., Gyeonggi-Do (KR)

(72) Inventor: Shuxue Quan, San Diego, CA (US)

(21) Appl. No.: 18/991,690

(22) Filed: Dec. 22, 2024

(51) Int. Cl. G06T 19/20; G06T 1/20; G06T 15/50

(52) U.S. Cl. CPC G06T 19/20; G06T 1/20; G06T 15/503; G06T 2219/2012

(57) ABSTRACT

A device includes a memory circuit capable of storing a non-uniform 3-dimensional lookup table (3D LUT) specifying color correction data. For one or more of a red dimension, a green dimension, and a blue dimension, the non-uniform 3D LUT includes a number of color correction values within one or more first light ranges of the non-uniform 3D LUT that exceeds a number of color correction values included within one or more second light ranges of the non-uniform 3D LUT. The device includes a color correcting circuit capable of transforming a source frame into a color corrected frame using the non-uniform 3D LUT.

### TECHNICAL FIELD

This disclosure relates to image processing and, more particularly, to color correction and/or color enhancement of digital images using non-uniform 3-dimensional (3D) lookup table technology.

### BACKGROUND

Visual See-Through (VST) is a technology used in a variety of different types of electronic devices. VST technology refers to a circuit architecture that captures digital images of the real-world using one or more cameras of a VST device and renders the digital images on one or more displays of the VST device to a user in real time or in substantially real time. The real-world scenes may be displayed on the display(s) of the VST device as digital images or a sequence of digital images, also referred to as “frames,” as digital video. VST technology is also capable of overlaying one or more digital content items on the real-world view as presented on the display(s). The digital content items that are overlayed on the real-world views may include text, graphics, a user interface, or other digital content. VST technology is often included in devices used for Augmented Reality (AR), Mixed Reality (MR), and/or Extended Reality (XR).

Providing accurate color in the digital images as rendered on the displays of a VST device is a significant aspect of VST technology. Color correction is an image processing technique that is capable of addressing nonlinearities in display(s). Appreciably, any color correction applied in the context of a VST device must be performed in real time.

One type of color correction applies a static 3×3 color correction matrix, e.g., a two-dimensional (2D) color correction matrix, to digital images. Typically, this type of color correction technique is performed as part of an offline rendering process not intended for real time applications such as VST technology. Notwithstanding, conventional color correction techniques such as those that utilize 3×3 matrix color correction matrices are unable to achieve sufficient levels of color correction of digital images in the case of VST devices. For example, a VST device that uses a conventional color correction technique involving a 3×3 static matrix is unable to provide adequate improvement in color accuracy for digital images with respect to brightness, desaturation, shadow, mid tones, and/or high lights.

### SUMMARY

In one or more embodiments, a device includes a memory circuit capable of storing a non-uniform 3-dimensional lookup table (3D LUT) specifying color correction data. For one or more of a red dimension, a green dimension, and a blue dimension of a red, green, blue (RGB) color space, the non-uniform 3D LUT includes a number of color correction values within one or more first light ranges of the non-uniform 3D LUT that exceeds a number of color correction values included within one or more second light ranges of the non-uniform 3D LUT. The device includes a color correcting circuit capable of transforming a source frame into a color corrected frame using the non-uniform 3D LUT.

In one or more embodiments, a device includes a Visual See-Through (VST) circuitry capable of processing frames in real time. The VST circuitry includes a memory circuit capable of storing a non-uniform 3D LUT specifying red, green, and blue color correction values for image processing. The VST circuitry includes a color correcting circuit capable of transforming a source frame into a color corrected frame using the non-uniform 3D LUT.

In one or more embodiments, a method of color correction includes storing a non-uniform 3D LUT specifying color correction data in a memory circuit. For one or more of a red dimension, a green dimension, and a blue dimension of a red, green, blue (RGB) color space, the non-uniform 3D LUT includes a number of color correction values within one or more first light ranges of the non-uniform 3D LUT that exceeds a number of color correction values included within one or more second light ranges of the non-uniform 3D LUT. The method includes receiving, from a camera, a source frame. The method includes transforming the source frame into a color corrected frame using the non-uniform 3D LUT.

This Summary section is provided merely to introduce certain concepts and not to identify any key or essential features of the claimed subject matter. Many other features and embodiments of the disclosed technology will be apparent from the accompanying drawings and from the following detailed description.

### BRIEF DESCRIPTION OF THE DRAWINGS

The accompanying drawings show one or more embodiments; however, the accompanying drawings should not be taken to limit the disclosed technology to only the embodiments shown. Various aspects and advantages will become apparent upon review of the following detailed description and upon reference to the drawings.

FIG. 1 illustrates an electronic device in accordance with one or more embodiments of the disclosed technology.

FIG. 2 illustrates an example circuit architecture for a Visual See-Through pipeline circuit in accordance with one or more embodiments of the disclosed technology.

FIG. 3 illustrates a color correction subsystem in accordance with one or more embodiments of the disclosed technology.

FIG. 4 illustrates an example of a uniform 3-dimensional lookup table (3D LUT).

FIGS. 5A and 5B illustrate examples of non-uniform 3D LUTs in accordance with one or more embodiments of the disclosed technology.

FIG. 6 illustrates a 3D LUT generation circuit in accordance with one or more embodiments of the disclosed technology.

FIG. 7 illustrates a method of image processing in accordance with one or more embodiments of the disclosed technology.

FIG. 8 illustrates a method of dynamically generating non-uniform 3D LUTs in accordance with one or more embodiments of the disclosed technology.

### DETAILED DESCRIPTION

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to image processing and, more particularly, to color correction and/or color enhancement of digital images using non-uniform 3-dimensional (3D) lookup table (LUT) technology. In accordance with the inventive arrangements disclosed herein, methods, systems (e.g., devices), and computer program products are provided that are capable of performing color correction and/or color enhancement (hereafter collectively referred to as “color correction”) using non-uniform 3D LUTs.

In one or more embodiments, the inventive arrangements are capable of providing color correction for devices that operate in dynamic lighting environments. Visual See-Through (VST) devices are examples of such devices. With a VST device, images from the cameras of the device and graphic content generated by a Graphics Processing Unit (GPU) of the device, for example, are processed through an image processing pipeline that implements multiple corrective operations. These corrective operations may include, but are not limited to, pupil swim correction, shearing correction, parallax correction, and asynchronous time warp. The application of these types of operations renders the use of a conventional, uniform 3×3 color correction matrix unable to provide adequate improvement in image quality, color fidelity, or the like. The inventive arrangements provide a flexible color transformation architecture that is capable of improving image quality for particular regions, e.g., different light regions, of a source digital image such as low light, shadow, medium light (e.g., “mid-tone”), and high light regions.

In one or more embodiments, color correction circuitry is disclosed that includes a non-uniform 3D LUT. The non-uniform 3D LUT is non-uniform in the sense that the 3D LUT includes a larger number of color correction values within one or more ranges than in other ranges. For example, the non-uniform 3D LUT may include, in one or more or in each of a red dimension, a green dimension, and a blue dimension, a same number of color correction values in total albeit with non-uniform spacing or distances between the color correction values in the particular dimensions. Given two or more equal ranges along a same axis of the non-uniform 3D LUT, two or more of the ranges may have different numbers of sample values.

In one or more embodiments, the regions of the non-uniform 3D LUT that have a higher number of color correction values may correspond to one or more different light ranges. That is, each axis of the non-uniform 3D LUT may have one or more numerical ranges that may be mapped onto particular lighting related visual characteristics that application of the non-uniform 3D LUT is intended to improve (e.g., mitigate or correct) in a source digital image. In examples described herein, this range, or these ranges, correspond to correcting particular lighting regions in a source digital image. For example, for each of the red dimension, the green dimension, and the blue dimension, the non-uniform 3D LUT may include a larger number of color correction values within at least one of a low light range or a high light range of the non-uniform 3D LUT than a number of color correction values included within a medium light range of the non-uniform 3D LUT. In other words, along any one or more or each of the axes in the non-uniform 3D LUT, the distance between consecutive color correction values in the enumerated range(s) may be smaller than is found between consecutive color correction values on the axis or axes outside of the enumerated ranges.

The non-uniformly distributed color correction values along one or more or all axes of the non-uniform 3D LUT improves performance of color correction over uniform LUTs. The non-uniformity of the non-uniform 3D LUT provides increased granularity in color correction for particular regions of the source digital image of interest. Often, these regions correspond to low light and/or high light regions of the source digital image. The increased granularity provided by the non-linear sampling of the non-uniform 3D LUT provides improved color correction for low light and/or high light regions as noise and color fidelity in such regions is more perceivable by users in displayed frames than in other regions.

In one or more embodiments, the device is included in an image processing pipeline of a VST device. In this regard, the image processing pipeline is capable of performing color correction using the non-uniform 3D LUT in real time to support operation of the VST device without an amount of latency that exceeds a predetermined maximum. VST latency refers to the time delay between an occurrence of an event in the real-world and a time that the event is displayed or rendered on the display(s) of the VST device. In other words, VST latency measures the time required for camera(s) and/or image sensor(s) of the VST device to capture image data, e.g., video, of the real-world, perform any processing on the captured image data, and render the processed image data specifying the real-world view on the display(s). In order for the VST device to provide what feels to the user as real-time operation and to avoid inducing user discomfort such as motion sickness, VST latency should be kept as low as possible.

In one or more embodiments, the non-uniform 3D LUT may be dynamically generated in a manner that adapts to the particular source digital image being processed. The adaptation may depend on a combination of one or more pre-calibrated 3D LUTs referred to herein as 3D basis LUTs. Combining of the 3D basis LUTs may be performed based on certain characteristics of the source digital image being processed. In any case, the non-uniform 3D LUT that is ultimately applied to the source digital image for color correction may be generated from the 3D basis LUTs and, as such, will be based on the content of the source digital image.

Further aspects of the inventive arrangements are described below in greater detail with reference to the figures. For purposes of simplicity and clarity of illustration, elements shown in the figures are not necessarily drawn to scale. For example, the dimensions of some of the elements may be exaggerated relative to other elements for clarity. Further, where considered appropriate, reference numbers are repeated among the figures to indicate corresponding, analogous, or like features.

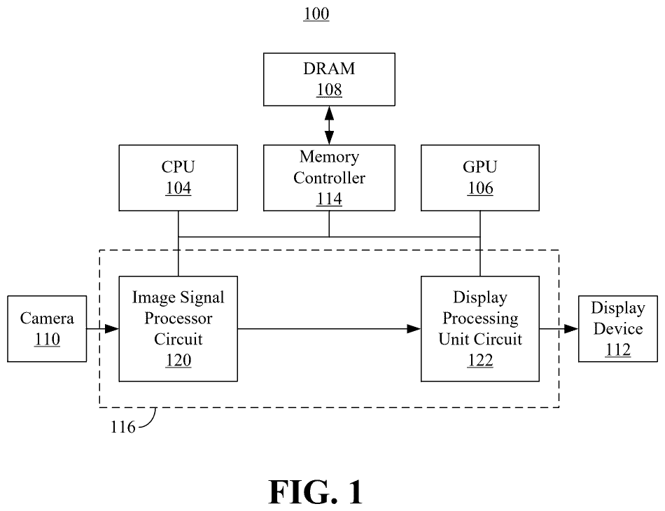

FIG. 1 illustrates an electronic device 100 in accordance with one or more embodiments of the disclosed technology. Electronic device 100 is capable of performing image processing. In the example, electronic device 100 includes a Central Processing Unit (CPU) 104, a GPU 106, a Dynamic Random-Access Memory (DRAM) 108, a camera 110, a display device 112, memory controller 114, and a VST pipeline circuit 116. In the example, VST pipeline circuit 116 includes an ISP circuit 120 and a DPU circuit 122. In one or more examples, memory controller 114 and VST pipeline circuit 116 are disposed in a same die. In one or more other examples, VST pipeline circuit 116 may include an on-die memory (not shown). The on-die memory circuit may be used to implement data buffers for circuit blocks within each of ISP circuit 120, DPU circuit 122, and between ISP circuit 120 and DPU circuit 122. The on-die memory circuit may be implemented as Static Random-Access Memory (SRAM) or an embedded DRAM (e-DRAM) that is disposed or implemented on the same die as VST pipeline circuit 116.

In the example, an image data feed originates with camera 110 and continues through ISP circuit 120, DPU circuit 122, and ends with display device 112. This signal path, e.g., the VST pipeline circuitry 116, is often considered a timing critical path to be implemented with low latency for a VST device. This data path may include a plurality of buffers implemented in an on-die memory (not shown). In general, ISP circuit 120 is capable of performing image processing operations relating to image data output from camera 110. DPU circuit 122 is capable of blending digital content items generated by GPU 106 with the image data generated by camera 110. VST pipeline circuit 116 encapsulates or includes the low latency data path through which image data is conveyed from camera 110 to display device 112. In one or more embodiments, VST pipeline circuit 116 is capable of achieving a VST latency of approximately 10 milliseconds or less.

Camera 110 may be implemented using any of a variety of digital image capture technologies. For example, camera 110 may utilize one or more optical sensors such as a charged coupled device (CCD), a complementary metal-oxide semiconductor (CMOS) optical sensor, or the like. In one or more embodiments, camera 110 is implemented as a digital Red-Green-Blue (RGB) camera. Camera 110 is capable of capturing and outputting image data as one or more, or a sequence of, frames. The frames may specify real-world scenes or views. The frames may be output to ISP circuit 120.

Within this disclosure, a frame refers to a digital image, e.g., digital data, specifying an image. Appreciably, video may be specified as a sequence of a plurality of frames. In addition, within this disclosure, the term “image data” may refer to an entire frame or a portion of a frame, e.g., one or more lines of the frame. Image data, as processed through VST pipeline circuit 116, may be specified or formatted and/or transformed into one or more different image encoding formats and/or one or more different color spaces. Those skilled in the art will appreciate that the particular image encodings, formatting, compression/decompression techniques, and/or color spaces discussed are for purposes of illustration and not limitation.

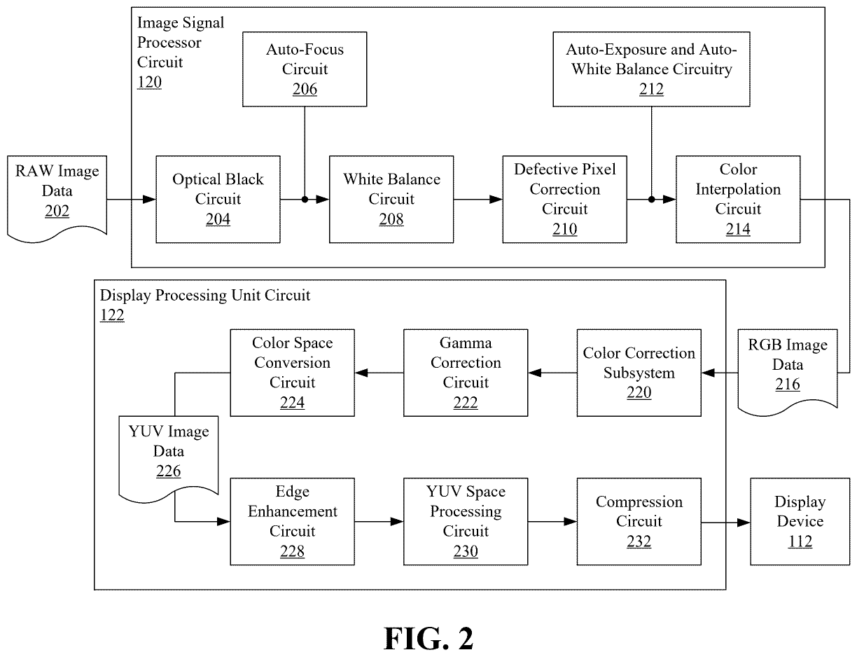

ISP circuit 120 is capable of performing various image processing operations. As noted, ISP circuit 120 is capable of processing image data generated and output by camera 110. In one or more embodiments, DPU circuit 122 includes one or more hardened circuit blocks configured to perform image processing functions that were conventionally performed as software executable operations in a GPU. Examples of operations performed by ISP circuit 120 are described in greater detail in connection with FIG. 2.

DPU circuit 122 is capable of blending image data output from ISP circuit 120 with digital content items generated and/or output from GPU 106 into merged image data (e.g., one or more merged frames). For example, DPU circuit 122 is capable of overlaying one or more digital content items as generated by GPU 106 on the image data. DPU circuit 122 may include one or more hardened circuit blocks configured to perform image processing functions that were conventionally performed as software executable operations in a GPU. DPU circuit 122 optionally may include one or more additional hardened circuit blocks to be described in greater detail hereinbelow. DPU circuit 122 is coupled to display device 112.

The circuit architecture illustrated in FIG. 1 allows ISP circuit 120 and DPU circuit 122 to access data from an on-die memory without having to utilize memory controller 114 to access DRAM 108, which may be located off-die with respect to VST pipeline circuit 116. In this regard, the data path of VST pipeline circuit 116, which effectively moves frames from camera 110 to display device 112, may be kept entirely on-die, e.g., on a single die.

Display device 112 may be implemented as any of a variety of display screens. For example, display device 112 may be implemented as a liquid crystal display (LCD), a light emitting diode (LED) display, an organic light emitting diode (OLED) display, a quantumdot light emitting diode (QLED) display, a microelectromechanical systems (MEMS) display, or an electronic paper display. Display device 112 may be implemented as a depth-aware display, such as a multi-focal display. Display device 112 is capable of displaying, for example, various types of content such as text, images, videos, icons, symbols, and the like, to a user. In one or more embodiments, display device 112 may include a touchscreen and may receive, for example, a touch, gesture, proximity, or hovering input using an electronic pen or a body portion of the user.

In one or more embodiments, CPU 104 is capable of controlling operation of VST pipeline circuit 116. For example, CPU 104 is capable of implementing or managing the control path of the low latency data path implemented by VST pipeline circuit 116 by controlling operation of the various circuit blocks of VST pipeline circuit 116 and/or GPU 106.

In the example, CPU 104 may be implemented as one or more hardware processors. CPU 104 may be implemented as one or more circuits capable of executing computer-readable program instructions (program instructions). In one or more examples, CPU 104 may include one or more cores, for example, where each core is capable of executing computer-readable program instructions. CPU 104 may be implemented using any of a variety of architectures such as, for example, a complex instruction set computer architecture (CISC), a reduced instruction set computer architecture (RISC), a vector processing architecture, or other known architectures. For example, a hardware processor may be implemented using an x86 architecture (e.g., IA-32, IA-64), a Power Architecture, as an ARM processor, or the like.

GPU 106 is capable of generating the digital content items that may be overlayed, or super-imposed, over image data originating in camera 110. GPU 106 may be implemented as one or more hardware processors. GPU 106, for example, may include a plurality of cores or compute units that are particularly suited for performing graphics and/or image processing operations.

In one or more embodiments, CPU 104 and GPU 106 are not disposed on the same die as VST pipeline circuit 116. For example, the die including VST pipeline circuit 116 may be implemented as a chiplet while CPU 104 and GPU 106 are implemented in one or more other chiplets coupled to die 102. In one or more embodiments, the die on which VST pipeline circuit 116 is disposed may be included in a same IC package as die(s) on which CPU 104 and/or GPU 106 are disposed. In one or more embodiments, the die on which VST pipeline circuit 116 is disposed may be included in a different IC package than the die(s) on which CPU 104 and/or GPU 106 are disposed.

Electronic device 100 may be implemented as, or within, any of a variety of different types of systems in which video from a camera, or cameras, is to be delivered in substantially real time to a display or displays. Electronic device 100 may be embodied as a computer system, a communication device, an information appliance, or the like. In one or more embodiments, electronic device 100 may be integrated into a wearable device or an electronic device-mountable wearable device such as a head-mounted device (HMD). For example, electronic device 100 may represent an AR wearable device, such as a headset or smart eyeglasses. In the case of certain HMDs, elements of VST pipeline circuit 116 may be duplicated to work with an additional camera and an additional display device. For example, a second ISP circuit 120 and a second DPU circuit 122 may be included. The additional components may utilize the same on-die memory for on-die buffers, but constitute a further VST pipeline circuit to process data from an additional camera and output the processed data to an additional display.

FIG. 2 illustrates an example circuit architecture for VST pipeline circuit 116 in accordance with one or more embodiments of the disclosed technology. In the example, ISP circuit 120 receives image data from camera 110 as RAW image data 202. ISP circuit 120 includes an optical black circuit 204, an auto-focus circuit 206, a white balance circuit 208, a defective pixel correction circuit 210, an auto-exposure and auto-white balance circuitry 212, and a color interpolation circuit 214.

In the example, RAW image data 202 may be received by optical black circuit 204. Optical black circuit 204 is capable of applying a sensor-black offset correction to RAW image data 202. Optical black circuit 204 is capable of applying a correction to the noise inherent to all sensors to achieve improved image contrast. Auto-focus circuit 206 is capable of analyzing received RAW image data 202 for sharpness and generating one or more control signals provided to camera 110 to control the focus of camera 110. In the example, auto-focus circuit 206 need not be in the image processing pipeline as auto-focus circuit 206 is capable of controlling focus of camera 110 and is not outputting a processed version of the image data for consumption by downstream circuit blocks.

White balance circuit 208 is capable of adjusting a color temperature of RAW image data 202 to ensure that objects that are white in real life appear white as the processed image data is rendered on display device 112. Defective pixel correction circuit 210 is capable of correcting defective or dead pixels in RAW image data 202 to improve image quality. Auto exposure and auto white balance circuitry 212 is capable of generating statistics for RAW image data 202 with respect to auto-exposure and white balance. The statistics, as generated, may be provided to color interpretation circuit 214. Color interpretation circuit 214 is capable of applying the statistics to perform white balancing and digital gain adjustments to RAW image data 202 that improve uniformity of the image data. In particular examples, color interpolation circuit 214 is also capable of converting RAW image data 202 into RGB image data 216 for conveyance to DPU circuit 122.

DPU circuit 122 may include a color correction subsystem (e.g., circuitry) 220, gamma correction circuit 222, color space conversion circuit 224, edge enhancement circuit 228, YUV space processing circuit 230, and compression circuit 232. In the example, compression circuit 232 may be coupled to display device 112.

Color correction subsystem 220 is capable of performing color correction on RGB image data 216 (e.g., a source frame) using a non-uniform 3D LUT in accordance with one or more embodiments of the disclosed technology. Gamma correction circuit 222 is capable of performing gamma mapping (e.g., inverse gamma) on RGB image data 216 to provide further visual enhancement of the image data. In one or more embodiments, gamma correction circuit 222 is capable of correcting for non-linearities in luminance data of RGB image data 216. Color space conversion circuit 224 is capable of converting RGB image data 216 into the YUV color space as YUV image data 226. Converting the color space to YUV reduces the bandwidth required for further processing of the image data and reduces the amount of storage needed to store the image data along VST pipeline circuit 116.

Edge enhancement circuit 228 is capable of performing image processing functions that specifically focus on highlighting boundaries between different areas of an image by emphasizing high-frequency details. Edge enhancement circuit 228 is capable of adjusting YUV image data 226 to make edges appear sharper. YUV space processing circuit 230 is capable of performing image processing operations such as adjusting luminance (e.g., brightness) while preserving color information (chrominance) on YUV image data 226. Compression circuit 232 is capable of compressing YUV image data 226 as output from YUV space processing circuit 230 for conveyance to display device 112. Display device 112 may decompress the data and present the image data thereon as a sequence of color corrected frames (e.g., as video).

FIGS. 1 and 2 are provided for purposes of illustration and not limitation. In the examples of FIGS. 1 and 2, the various blocks illustrated may be implemented as hardened circuit blocks. The various image processing techniques described in connection with blocks 204, 206, 208, 210, 212, 214, 222, 224, 228, 230, and/or 232 may be hardened circuit block implementations of available or known image processing functions as described.

The examples of FIGS. 1 and 2 are provided to illustrate various use cases and/or scenarios in which color correction in accordance with the inventive arrangements may be performed. For example, color correction subsystem 220, in accordance with the inventive arrangements described herein, may be included in the location illustrated in the example of FIG. 2, at one or more other locations in the alternative to the location illustrated in the example of FIG. 2, or at one or more other locations in addition to the location illustrated in the example of FIG. 2. In one or more other examples, color correction subsystem 220 may be incorporated into one or more locations in the signal flow of ISP circuit 120.

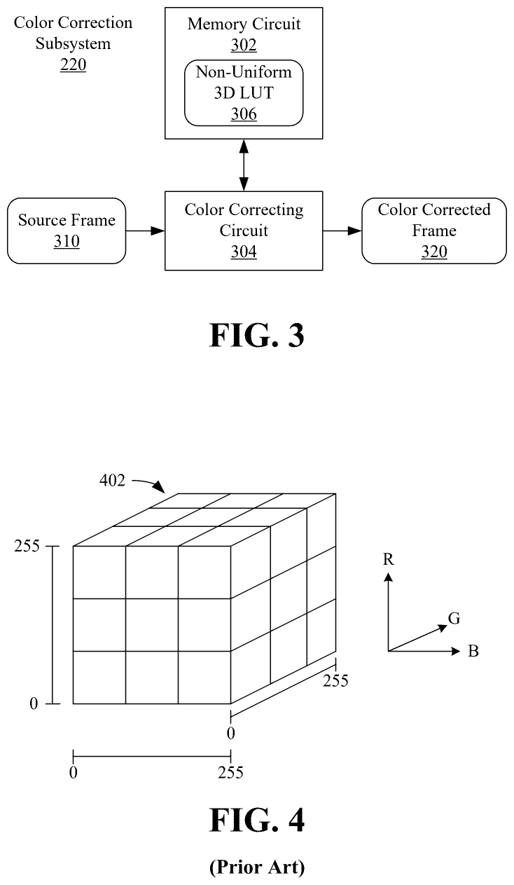

FIG. 3 illustrates color correction subsystem 220 in accordance with one or more embodiments of the disclosed technology. In the example of FIG. 3, color correction subsystem 220 includes a memory circuit 302 and a color correcting circuit 304. Memory circuit 302 is capable of storing a non-uniform 3D LUT 306 therein. Memory circuit 302 may be implemented as any of a variety of different memory circuits. Examples of memory circuit 302 include SRAM, e-DRAM, register memory, non-volatile memory, or the like.

In the example of FIG. 3, color correcting circuit 304 is capable of receiving a source frame 310. Source frame 310 may be specified in the RGB color space. Color correcting circuit 304 is capable of applying non-uniform 3D LUT 306 to source frame 310 to generate a color corrected frame 320. Color correcting circuit 304 is capable of transforming source frame 310 into color corrected frame 320 by determining or calculating color corrected pixel values for source frame 310 from non-uniform 3D LUT 306.

For example, for each pixel of source frame 310, color correcting circuit 304 is capable of indexing into non-uniform 3D LUT 306 to located color corrected pixel values that may be output as color corrected frame 320. In cases where specific sample values are not specified by non-uniform 3D LUT 306 for a given input value or values, color correcting circuit 304 is capable of performing an interpolation technique to generate color corrected values based on the closest available color correction values specified by non-uniform 3D LUT 306 given the input value(s) from source frame 310 for any given pixel.

In one or more embodiments, in using non-uniform 3D LUT 306, one or more different types of interpolation may be used. Any of a variety of known or available interpolation techniques may be used such as geometrical interpolation techniques and/or cellular regression interpolation techniques. In one or more other examples, prism interpolation may be used. Prism interpolation may be used to interpolate any combination of the input signal, for example, where the input signal range is from 0 to 255 for each of red, green, and blue. Prism interpolation refers to a technique of estimating values for non-specified sample points of the non-uniform 3D LUT 306 based on a known or predetermined standard curve. For example, a curve may be fit to the values specified by the non-uniform 3D LUT 306 and then used to perform interpolation for any unspecified color correction values not specified for a given input by non-uniform 3D LUT 306. Other examples of geometrical interpolations that may be used may include, but are not limited to, trilinear, pyramid, and/or tetrahedral. The example interpolation techniques described within this disclosure are not intended to be limiting of the inventive arrangements and are provided for purposes of illustration only. Other suitable interpolation techniques may be used.

In the example of FIG. 3, color correcting circuit 304, which is included in VST circuitry such as VST pipeline circuit 116, is capable of processing a plurality of source frames sequentially in real time to generate corresponding color corrected frames. In this regard, the VST circuitry including color correcting circuit 304 is capable of transforming video into a color corrected video in real time.

FIG. 4 illustrates an example of a uniform 3D LUT 402. In the example, uniform 3D LUT 402 specifies color correction values in each of 3-dimensions corresponding to red (R), green (G), and blue (B). Given a red, green, and blue value for a pixel in a source frame specified as (R, G, B), a value for each of red, green, and blue may be retrieved from uniform 3D LUT 402 to be used for the pixel (e.g., for the same pixel location) in the color corrected frame. For purposes of illustration, each axis may specify a value between 0 and 255. Rather than provide a 3D LUT structure that is 255×255×255, which requires a significant amount of memory for storage, a particular step-size of N may be specified to down-sample the uniform 3D LUT. As an example, a step size of N=16 may be used. That is, in the example of FIG. 4, the uniform 3D LUT 402 may specify data, or have sample points, at intervals of 16 along each axis (e.g., 0, 15, 31, 63, . . . 255) to reduce the size of the uniform 3D LUT.

In one or more embodiments, the number of sample points, e.g., color correction values, in particular range(s) of a 3D LUT may be adjusted so that a larger number of color correction values are provided in one or more selected range(s) than in other range(s). That is, the number of sample points or color correction value specified in one or more ranges exceeds the number of sample values in one or more other ranges for one or more or each axis.

As an example, given the above uniform 3D LUT 402 having sample points (color correction values) at increments of 16 (e.g., N=16), the 3D LUT 402 will include 16 total sample points along each axis resulting in a 16 3D LUT. Image quality may be improved by providing additional sample points for certain ranges along one or more or each axis while maintaining the total number of sample points constant. That is, for one or more designated ranges of interest, for one or more or each axis of the 3D LUT, the value of N (e.g., step size or distance between consecutive sample points) may be varied (e.g., reduced). In other non-designated ranges, the value of N may be increased. By adjusting the value of N for certain ranges along certain axes of the 3D LUT, the granularity of color correction values provided is increased in the designated range(s). In one or more embodiments, the particular range(s) that are designated and, as such, the ranges in which N may be reduced, may be selected based on lighting or lighting condition.

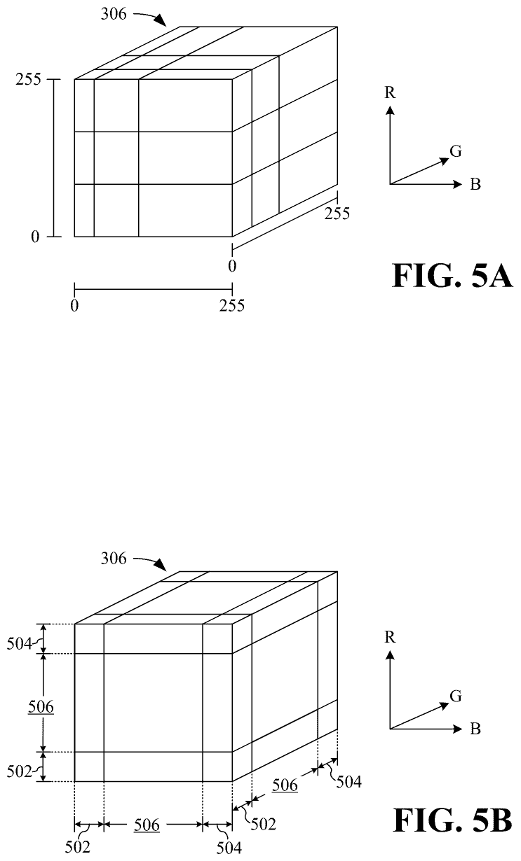

FIGS. 5A and 5B illustrate examples of non-uniform 3D LUT 306 in accordance with one or more embodiments of the disclosed technology. In each of FIGS. 5A and 5B, non-uniform 3D LUT 306 may be specified as a non-uniform lattice that includes samples (e.g., color correction values) with increased granularity in one or more designated ranges. Non-uniform 3D LUT 306 has color correction values in at least one, e.g., in one or more, of the 3 dimensions that are not equally distributed.

In the examples of FIGS. 5A and 5B, one or more ranges have been designated to use a value of N that is less than the value of N used in at least one other range along the same axis. These ranges may be different light ranges referring to intensity of the particular red, green, and/or blue value. As an example, the ability of a user to see detail within low light areas of a frame and/or high light areas of a frame is/are important aspects of user perception of image quality. In view of the significance of these areas of a frame, the inventive arrangements increase the granularity of range(s) of the 3D LUT that correspond to (e.g., are used to color correct) low light and/or high light areas of a frame. The granularity of range(s) of the 3D LUT that correspond to non-designated areas such as medium light areas of a frame may be reduced (e.g., use a higher value of N).

Referring to FIG. 5B, non-uniform 3D LUT 306 may include a limited number of sample points along each axis. For purposes of illustration, consider an example in which there are 16 sample points along each of the R, G, and B axes. In this example, the distance or spacing between different sample points may be varied based on lighting and/or lighting intensity. The intervals between sample points may be changed to be nonuniform (e.g., not occurring in increments of 16 in the range of 0-255 or varying in the range of 0-255). It should be appreciated that the range of 0-255 is used for purposes of illustration and that other ranges may be used depending different considerations such as the implementation of the system, the number of bits available for representing quantities, and/or the desired size of the non-uniform 3D LUT 306.

In the example of FIG. 5B, a low light range of non-uniform 3D LUT 306 corresponds to the range of 0 to approximately 48 and is represented as low light range 502 along each axis. Within each low light range 502, non-uniform 3D LUT 306 may include 6 different sampling points (e.g., N=8) rather than 3 in the case where N=16. Similarly, within a high light range of non-uniform 3D LUT 306 corresponding to a range of 208-255 and illustrated as high light range 504 along each axis, non-uniform 3D LUT 306 may include 6 different sampling points (e.g., N=8) rather than 3 in the case where N=16. For the range 49-207, which corresponds to medium light and is illustrated as medium light range 506 on each axis, the remaining 4 sampling points may be used with a different value of N (e.g., N≈39.5). Using this non-uniform sampling, increased granularity may be provided by non-uniform 3D LUT 306 for any designated range or light region.

FIG. 5, in reference to FIGS. 5A and 5B, illustrates an example technique for down-sampling to generate non-uniform 3D LUT 306. For example, rather than uniformly down-sampling a uniform 3D LUT that is 255×255×255, the down-sampling preserves or keeps samples in different ranges in a non-uniform manner. Rather than discarding samples and keeping every N samples where N=16 for the entire range of 0 to 255 in each color dimension, the value of N may be changed in different ranges of the 0-255 in along each color dimension.

In the examples above, the value of N is described as being constant throughout each of the various ranges discussed (e.g., in each of 0-48, 49-209, and 208-255). In one or more other examples, the value of N still may vary. That is, specific sample points may be selected for different ranges such that the distance between consecutive sample points in a given range or in each of the ranges is not constant. Such selection of sample points may be based on an evaluation of a quality of the color correction achieved using the resulting non-uniform 3D LUT. It also should be appreciated that the particular ranges designated as low light, medium light, and high light may vary from the example ranges provided. Still, each range may be specified based on lighting conditions and/or ambient light of the source frame(s) being processed.

In one or more embodiments, in each of the red dimension, the green dimension, and the blue dimension, the non-uniform 3D LUT includes a number of color correction values (e.g., a number of sample points) within the low light range (e.g., a first light range) of the non-uniform 3D LUT 306 that exceeds a number of color correction values included within a medium light range (e.g., a second light range) of the non-uniform 3D LUT. In one or more embodiments, in each of the red dimension, the green dimension, and the blue dimension, the non-uniform 3D LUT 306 includes a number of color correction values (e.g., a number of sample points) within the high light range (e.g., a first light range) of the non-uniform 3D LUT that exceeds a number of color correction values included within a medium light range (e.g., a second light range) of the non-uniform 3D LUT. In one or more embodiments, in each of the red dimension, the green dimension, and the blue dimension, the non-uniform 3D LUT includes a number of color correction values (e.g., a number of sample points) within both the low light range and the high light range of the non-uniform 3D LUT that exceeds a number of color correction values included within a medium light range of the non-uniform 3D LUT.

By increasing the granularity of the non-uniform 3D LUT 306 for those particular areas of interest in a given source frame to be processed, the resulting image quality in the color corrected frame is increased as the level of detail in selected light regions such as low light regions and/or high light regions of the color corrected frame is increased. In one or more embodiments, the number of color correction values (e.g., samples) within at least one of the low light range or the high light range of the non-uniform 3D LUT has twice the number of color correction values than the number of color correction values included within the medium light range of the non-uniform 3D LUT.

In one or more embodiments, a number of color correction values in each of the red dimension, the green dimension, and the blue dimension of the non-uniform 3D LUT is equal. For example, the total number of sample points for each dimension may be the same. For example, as described above, each dimension may have a total of 16 sample points. In one or more embodiments, a number of color correction values in at least two of the red dimension, the green dimension, or the blue dimension of the non-uniform 3D LUT are not equal. In that case, different color dimensions may have a different total number of samples. For example, while 16 may be used for red and/or green, only 8 may be used for blue.

In one or more examples, non-uniform 3D LUT 306 may be implemented as a predetermined 3D LUT. That is, 3D LUT 306 may be created as a static 3D LUT that is applied for color correction. In one or more other examples, non-uniform 3D LUT 306 may be adapted to source frame 310.

In one or more embodiments, the defined first and/or second ranges (e.g., the boundaries of the low, medium, and/or high light ranges) may be different for different color dimensions in the non-uniform 3D LUT 306. That is, the low and/or high light range for the red dimension may be different from the corresponding light range for the green dimension and/or for the blue dimension. As an illustrative and non-limiting example, the low light region of the red, green, and blue dimensions for non-uniform 3D LUT 306 may be 0-48, 0-49, and/or 0-60, respectively. In some cases, less information is necessary in some dimension. In this example, the range for the blue dimension may be larger than for the red and green dimensions resulting in fewer sample points spread out over a larger distance for cases in which users do not perceive detail in images in the blue dimension as easily or as well as in the red and/or green dimensions.

In one or more embodiments, the number of sample points in the different light ranges may differ in the red dimension compared to the green dimension and/or the blue dimension in the non-uniform 3D LUT 306. For example, in the low light range, the number of sample points in the red dimension may be twice that included in the low light range in the green and/or blue dimensions. In this example, the light ranges (e.g., the low light range and/or the high light range) may be the same or different in reference to the boundaries of the respective light ranges.

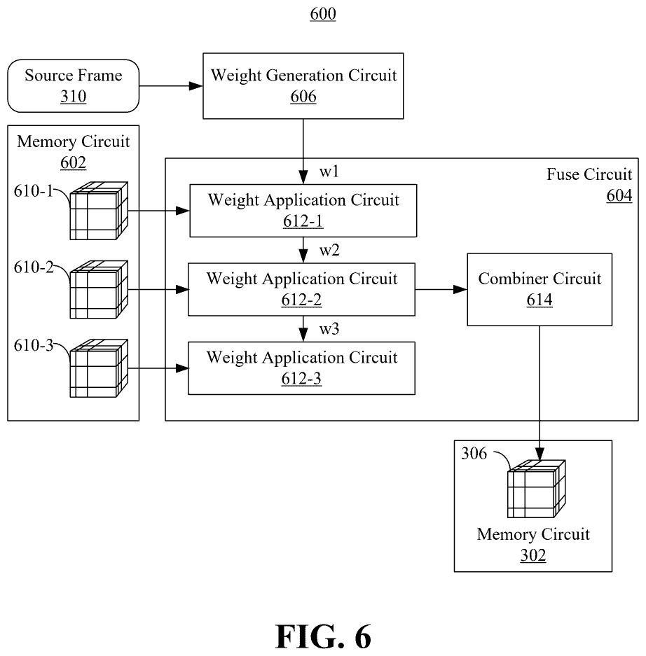

FIG. 6 illustrates a 3D LUT generation circuit 600 in accordance with one or more embodiments of the disclosed technology. In one or more embodiments, 3D LUT generation circuit 600 may be included within, or as part of, color correction subsystem 220. For example, 3D LUT generation circuit 600 may be used to generate adaptive versions of non-uniform 3D LUT 306 that, once generated, may be stored in memory circuit 302. 3D LUT generation circuit 600 is capable of generating a non-uniform 3D LUT such as non-uniform 3D LUT 306 for use in color correcting source frames. In the example of FIG. 6, the non-uniform 3D LUT as generated is adapted to the source frame. That is, the non-uniform 3D LUT, as generated, is specific to the particular source frame being processed. In this regard, the non-uniform 3D LUT may be dynamically generated for each different source frame that is received in real time.

In the example of FIG. 6, 3D LUT generation circuit 600 includes a memory circuit 602, a fuse circuit 604, and a weight generation circuit 606. Fuse circuit 604 includes a plurality of weigh application circuits 612 (e.g., 612-1, 612-2, and 612-3) and a combiner circuit 614.

3D basis LUT memory circuit 602 is capable of storing a plurality of different 3D basis LUTs 610 (e.g., 610-1, 610-2, and 610-3). Examples of memory circuit 602 include SRAM, e-DRAM, register memory, non-volatile memory, or the like. In the example, each 3D basis LUT 610 is generated to improve or correct a particular or predetermined lighting condition in a frame. In the example, three different 3D basis LUTs 610 are illustrated. It should be appreciated that fewer than three or more than three different 3D basis LUTs 610 may be included or stored in memory circuit 602. As noted, regardless of the particular number of 3D basis LUTs 610, each is constructed to correct or improve a particular lighting condition. In the example, each 3D basis LUT 610 may be implemented as a non-uniform 3D LUT as described herein.

In general, fuse circuit 604 is capable of combining 3D basis LUTs 610 to generate non-uniform 3D LUT 306. The example of FIG. 6 provides a circuit architecture that is capable of dynamically generating non-uniform 3D LUT 306 and doing so in a manner that adapts non-uniform 3D LUT 306 to the particular source frame 310 to be color corrected. Thus, for each source frame 310, e.g., each frame of video, a new version of non-uniform 3D LUT 306 may be generated that is specifically targeted to correcting color in the frame.

In the example, source frame 310 is provided as input to a weight generation circuit 606. In one or more other embodiments, source frame 310 may first be provided to a down-sampling circuit that down-samples source frame 310 thereby allowing weight generation circuit 606 to operate on a down-sampled (e.g., smaller) version of source frame 310.

Weight generation circuit 606 is capable of generating, e.g., predicting, a plurality of weights and providing the plurality of weights to fuse circuit 604. Each of the weights generated is a content dependent weight derived from source frame 310 or a down-sampled version thereof. In one or more embodiments, weight generation circuit 606 may be implemented as a neural network classifier trained to estimate a current lighting condition from source frame 310. For example, weight generation circuit 606 may be implemented as a neural network classifier trained to classify the source frame according to a plurality of predetermined lighting conditions that directly map onto 3D basis LUTs 610.

In one or more examples, weight generation circuit 606 may be implemented as a convolutional neural network (CNN). In one or more particular example implementations, the neural network classifier may be implemented as MobileNet in reference to a CNN model designed for execution/operation in mobile devices to perform image classification and/or object detection. In one or more other particular example implementations, the neural network classifier may be implemented as EfficientNet, which is another variety of CNN model. The examples provided herein are for purposes of illustration and are not intended as limitations of the inventive arrangements.

The current lighting condition as detected by weight generation circuit 606 from source frame 310 is correlated with the calibrated light conditions represented by each 3D basis LUT 610. Weight generation circuit 606 is capable of outputting one weight for each 3D basis LUT 610 that defines the contribution of that 3D basis LUT 610 to the creation of non-uniform 3D LUT 306 based on the detected lighting conditions in source frame 310. In the examples described herein, the combination of the 3D basis LUTs 610 is linear.

For example, weight generation circuit 606 generates weights w1, w2, and w3 from source frame 310 and provides weight w1 to weight application circuit 612-1, weight w2 to weight application circuit 612-2, and weight w3 to weight application circuit 612-3. Each weight application circuit 612 multiplies the corresponding 3D basis LUT 610 by the received weight. For example, weight application circuit 612-1 multiplies 3D basis LUT 610-1 by weight w1. Weight application circuit 612-2 multiplies 3D basis LUT 610-2 by weight w2. Weight application circuit 612-3 multiplies 3D basis LUT 610-3 by weight w3. Each weight application circuit 612 outputs the result, e.g., an adjusted version of the 3D basis LUT, to combiner circuit 614. Combiner circuit 614 is capable of adding the results, e.g., the weight adjusted versions of the 3D basis LUTs 610, to generate non-uniform 3D LUT 306. In this manner, for each source frame received, e.g., each frame of video, weight generation circuit 606 is capable of generating a set of weights derived from the source frame and providing the weights to the respective weight application circuits 612 of fuse circuit 604. Fuse circuit 604 generates a new version of non-uniform 3D LUT 306 to be used to color correct the source frame 310.

By combining multiple 3D basis LUTs, each adapted to correct (or at least mitigate) a particular lighting condition, the resulting non-uniform 3D LUT is not only specifically adapted to correct lighting conditions in each source frame, but is also better suited to correct for a variety of different lighting conditions that may be present in the source frame resulting in improved image quality. Generating an adaptive version of non-uniform 3D LUT 306 in real time allows for the image processing/VST architecture to adjust to real-world lighting conditions dynamically and in real time. Any interpolation that is performed is performed using the adapted non-uniform 3D LUT. The examples described herein are capable of providing an improved MR experience by devices that incorporate the technology. The color correction techniques and circuit architectures described provide improved image quality and color fidelity particularly with low light, shadow, high light, and/or medium light portions of a scene (e.g., a source frame).

In one or more embodiments, weight generation circuit 606 may be trained offline (e.g., is pre-trained) to generate weights, e.g., one weight for each base 3D LUT 610, that specifies a contribution of the 3D basis LUT 610 toward creating non-uniform 3D LUT 306. Training frames may be provided to weight generation circuit 606 with the weights generated during training then provided to the respective weight application circuits 612. The weights are applied to each 3D basis LUT as described, albeit as part of the training process, with combiner circuit 614 generating a non-uniform 3D LUT to be used to color correct the training frame. A cost function may be used to quantify a difference between the color corrected training frame created using the non-uniform 3D LUT and a ground truth color corrected version of the training frame. The process may iterate until the weights converge (e.g., stop evolving or evolve at a rate below a predetermined rate of change) or the cost function yields a value indicating a difference that does not exceed some predetermined threshold difference. The training may be performed using paired or unpaired data in an end-to-end manner.

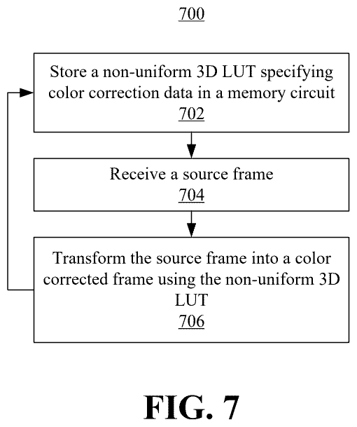

FIG. 7 illustrates a method 700 of image processing in accordance with one or more embodiments of the disclosed technology. Method 700 may be performed by color correction subsystem 220 as described in connection with FIG. 3. As discussed, color correction subsystem 220 may be included in an image processing pipeline such as a VST pipeline. In this regard, color correction subsystem 220 may be included in a VST device and is capable of performing real-time color correction of source frames and video.

In block 702, non-uniform 3D LUT 306 is stored in a memory circuit. Non-uniform 3D LUT 306 stores color correction data as described herein. In block 704, color correction subsystem 220, and more particularly color correcting circuit 304, receives source frame 310 (e.g., a frame of video) that is to be color corrected. In block 706, color correcting circuit 304 transforms source frame 310 into color corrected frame 320 using non-uniform 3D LUT 306. For example, color correcting circuit 304 is capable of color correcting the source frame using the non-uniform 3D LUT to adjust pixel values of source frame 310 to generate color corrected frame 320. Color correcting circuit 304 is capable of processing source frame 310 pixel-by-pixel to determine a color corrected pixel using non-uniform 3D LUT 306. After block 706, method 700 may loop back to block 702 to continue operation to color correct frames of a video in real time. It should be appreciated that color corrected frame 320 may be further processed through the image processing and/or VST pipeline and displayed on display device 112.

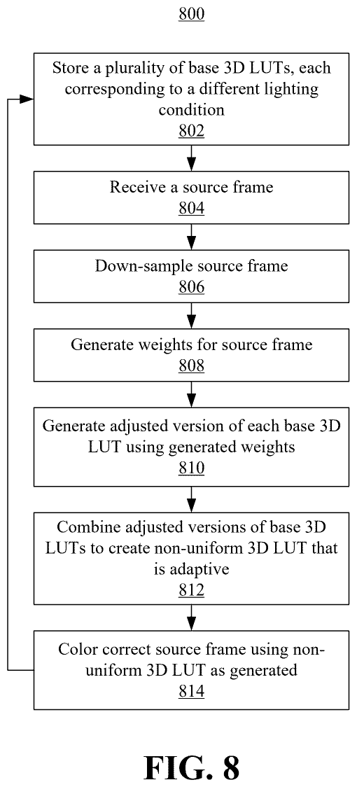

FIG. 8 illustrates a method 800 of dynamically generating non-uniform 3D LUTs in accordance with one or more embodiments of the disclosed technology. Method 800 may be performed by color correction subsystem 220 as described in connection with FIG. 3. More particularly, method 800 may be performed by the example circuitry described in connection with FIG. 6, which may be included with or added to color correction subsystem 220 described in connection with FIG. 3 and operate cooperatively therewith.

In block 802, a plurality of base 3D LUTs 610 are stored in a memory circuit 602. Each of the different base 3D LUTs 610 corresponds to a particular, e.g., a different lighting condition to be corrected or mitigated in a received source frame. In block 804, weight generation circuit 606 receives a source frame for processing. In block 806, the source frame is optionally down-sampled. In one or more embodiments, for example, weight generation circuit 606 includes a down-sampling circuit that is capable of generating a down-sampled version of the source image received.

In block 808, weight generation circuit 606 is capable of operating on the source image (or the down-sampled version thereof) to detect one or more different lighting conditions from content of the source image. In block 808, based on the lighting conditions detected, which may be correlated or the same as, the lighting conditions that each 3D basis LUT is intended to correct or mitigate, is capable of generating weights. Weight generation circuit 606 is capable of generating one weight for each 3D basis LUT.

In block 810, the weight application circuits 612 generate adjusted versions of each 3D basis LUT using the weights generated by weight generation circuit 606. The weights generated by weight generation circuit 606 may be distributed to the respective weight application circuits 612. Each weight application circuit 612, for example, is capable of multiplying the corresponding 3D basis LUT by the particular weight generated by weight generation circuit 606. In block 812, combiner circuit 614 is capable of combining the adjusted versions of 3D basis LUTs, e.g., adding the adjusted versions of the 3D basis LUTs, to create non-uniform 3D LUT, which is adaptive to the source image from which the weights were generated.

In block 814, color correcting circuit 304 is capable of color correcting the source frame using the non-uniform 3D LUT to adjust pixel values of the source frame to generate the color corrected frame. Thus, the source frame is color correcting using a non-uniform 3D LUT, as described herein, that is specifically suited to correct or mitigate the lighting conditions detected in the source frame. After block 814, method 800 may loop back to block 802 to continue operation to color correct frames of a video in real time. It should be appreciated that color corrected frame 320 may be further processed through the image processing and/or VST pipeline and displayed on display device 112.

The terminology used herein is for the purpose of describing particular embodiments only and is not intended to be limiting. Notwithstanding, several definitions that apply throughout this document now will be presented.

As defined herein, the singular forms “a,” “an,” and “the” are intended to include the plural forms as well, unless the context clearly indicates otherwise.

The term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without intervention from a human being.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. The different types of memory, as described herein, are examples of a computer readable storage mediums. A non-exhaustive list of more specific examples of a computer readable storage medium may include: a portable computer diskette, a hard disk, a random-access memory (RAM), a read-only memory (ROM), an erasable programmable read-only memory (EPROM or Flash memory), a static random-access memory (SRAM), a portable compact disc read-only memory (CD-ROM), a digital versatile disk (DVD), a memory stick, a floppy disk, or the like.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “one or more embodiments,” or similar language mean that a particular feature, structure, or characteristic described in connection with the embodiment is included in at least one embodiment described within this disclosure. Thus, appearances of the phrases “in one embodiment,” “in an embodiment,” “in one or more embodiments,” and similar language throughout this disclosure may, but do not necessarily, all refer to the same embodiment. The terms “embodiment” and “arrangement” are used interchangeably within this disclosure.

As defined herein, the term “output” means storing in physical memory elements, e.g., devices, writing to a display or other peripheral output device, sending or transmitting to another system, exporting, or the like.

As defined herein, the term “processor” means at least one hardware circuit. The hardware circuit may be configured to carry out instructions contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a Digital Signal Processor (DSP), a Graphics Processing Unit (GPU), and a controller.

As defined herein, the term “real time” means a level of processing responsiveness that a user or system senses as sufficiently immediate for a particular process or determination to be made, or that enables the processor to keep up with some external process.

As defined herein, the term “responsive to” and similar language as described above, e.g., “if,” “when,” or “upon,” mean responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

The term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The term “user” refers to a human being.

The terms first, second, etc. may be used herein to describe various elements. These elements should not be limited by these terms, as these terms are only used to distinguish one element from another unless stated otherwise or the context clearly indicates otherwise.

A computer program product may include a computer readable storage medium (or two or more, e.g., a plurality, of such mediums) having computer readable program instructions thereon for causing a processor to carry out aspects of the present disclosed technology. Within this disclosure, the term “program code” is used interchangeably with the terms “computer readable program instructions” and “program instructions.” Computer readable program instructions described herein may be downloaded to respective computing/processing devices from a computer readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Computer readable program instructions may specify state-setting data. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer readable program instructions by utilizing state information of the computer readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer readable program instructions, e.g., program code.

The flowchart and block diagrams in the Figures illustrate the architecture, functionality, and operation of possible implementations of systems, methods, and computer program products according to various aspects of the inventive arrangements. In this regard, each block in the flowcharts or block diagrams may represent a module, segment, or portion of instructions, which comprises one or more executable instructions for implementing the specified operations. In some alternative implementations, the operations noted in the blocks may occur out of the order noted in the figures. For example, two blocks shown in succession may be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts or carry out combinations of special purpose hardware and computer instructions.

The corresponding structures, materials, acts, and equivalents of all means or step plus function elements that may be found in the claims below are intended to include any structure, material, or act for performing the function in combination with other claimed elements as specifically claimed.

The description of the embodiments provided herein is for purposes of illustration and is not intended to be exhaustive or limited to the form and examples disclosed. The terminology used herein was chosen to explain the principles of the inventive arrangements, the practical application or technical improvement over technologies found in the marketplace, and/or to enable others of ordinary skill in the art to understand the embodiments disclosed herein. Modifications and variations may be apparent to those of ordinary skill in the art without departing from the scope and spirit of the described inventive arrangements. Accordingly, reference should be made to the following claims, rather than to the foregoing disclosure, as indicating the scope of such features and implementations.

What is claimed is:

1. A device, comprising:
a memory circuit capable of storing a non-uniform 3-dimensional lookup table (3D LUT) specifying color correction data;
wherein, for one or more of a red dimension, a green dimension, or a blue dimension, the non-uniform 3D LUT includes a number of color correction values within one or more first light ranges of the non-uniform 3D LUT that exceeds a number of color correction values included within one or more second light ranges of the non-uniform 3D LUT; and
a color correcting circuit capable of transforming a source frame into a color corrected frame using the non-uniform 3D LUT.

2. The device of claim 1, wherein the one or more first light ranges include at least one of a low light range or a high light range and the one or more second light ranges include a medium light range.

3. The device of claim 2, wherein the number of color correction values within the one or more first light ranges of the non-uniform 3D LUT that exceeds the number of color correction values included within the one or more second light ranges of the non-uniform 3D LUT occurs within the non-uniform 3D LUT for the red dimension, the green dimension, and the blue dimension.

4. The device of claim 1, wherein the source frame is one of a plurality of source frames of a video, the device further comprising:
a Visual See-Through (VST) pipeline circuit including the memory circuit and the color correcting circuit, wherein the VST pipeline circuit is capable of transforming the video into a color corrected video in real time.

5. The device of claim 1, wherein the non-uniform 3D LUT is adapted to the source frame.

6. The device of claim 1, further comprising:
a weight generation circuit capable of generating a plurality of weights based on the source frame; and
a fuse circuit capable of combining a plurality of 3D basis LUTs using the plurality of weights to generate the non-uniform 3D LUT.

7. The device of claim 6, wherein each 3D basis LUT corresponds to one of a plurality of different predetermined lighting conditions.

8. The device of claim 6, wherein the plurality of weights are generated based on a detected lighting condition of the source frame.

9. The device of claim 1, wherein a number of color correction values in each of the red dimension, the green dimension, and the blue dimension of the non-uniform 3D LUT is equal.

10. The device of claim 1, wherein a number of color correction values in at least two of the red dimension, the green dimension, and the blue dimension of the non-uniform 3D LUT are not equal.

11. A device, comprising:
a Visual See-Through (VST) pipeline circuit capable of processing frames in real time, wherein the VST pipeline circuit includes:
a memory circuit capable of storing a non-uniform 3-dimensional lookup table (3D LUT) specifying red, green, and blue color correction values for image processing; and
a color correcting circuit capable of transforming a source frame into a color corrected frame using the non-uniform 3D LUT.

12. The device of claim 11, wherein the non-uniform 3D LUT is adapted to the source frame.

13. The device of claim 11, further comprising:
a weight generation circuit capable of generating a plurality of weights based on the source frame; and
a fuse circuit capable of combining a plurality of 3D basis LUTs using the plurality of weights to generate the non-uniform 3D LUT.

14. The device of claim 13, wherein each 3D basis LUT corresponds to one of a plurality of different predetermined lighting conditions.

15. The device of claim 13, wherein the plurality of weights are generated based on a detected lighting condition of the source frame.

16. The device of claim 11, wherein a number of color correction values in each of a red dimension, a green dimension, and a blue dimension of the non-uniform 3D LUT is equal.

17. The device of claim 11, wherein a number of color correction values in at least two of a red dimension, a green dimension, and a blue dimension of the non-uniform 3D LUT are not equal.

18. A method of color correction for image data, comprising:
storing a non-uniform 3-dimensional lookup table (3D LUT) specifying color correction data in a memory circuit;
wherein, for one or more of a red dimension, a green dimension, or a blue dimension, the non-uniform 3D LUT includes a number of color correction values within one or more first light ranges of the non-uniform 3D LUT that exceeds a number of color correction values included within one or more second light ranges of the non-uniform 3D LUT; and
receiving, from a camera, a source frame; and
transforming the source frame into a color corrected frame using the non-uniform 3D LUT.

19. The method of claim 18, further comprising:
generating a plurality of weights based on the source frame; and
combining a plurality of 3D basis LUTs using the plurality of weights to generate the non-uniform 3D LUT.

20. The method of claim 18, wherein the source frame is one of a plurality of source frames of a video, wherein the transforming is capable of color correcting the video into a color corrected video in real time.
